(19) United States
(12) Patent Application Publication
(10) Pub. No.: US 2018/0345219 A1
(43) Pub. Date: Dec. 6, 2018

(54) Osmosis battery & high magnetic field generator & superconducting ionic current loop

(71) Applicant: Yanming Wei, Mountain (CA)

(72) Inventor: Yanming Wei, Mountain (CA)

(21) Appl. No.: 15/848,097

(22) Filed: Dec. 20, 2017

(51) Int. Cl. B01D 61/02; B01D 61/06; B01D 61/10; F03G 7/04; B01D 61/42

(52) U.S. Cl. CPC B01D 61/025; B01D 61/06; B01D 61/08; F03G 7/04; B01D 61/42; B01D 61/10

(57) ABSTRACT

It is a battery, but electricity output not from electrochemistry, only ionic current loop and its induced high magnetic field ready for use. The power comes from osmotic pressure without any chemical reaction. Recharging the battery can be done by reverse osmosis, or replacement of liquid media. Electrolyte, 2 or 3 liquid segments, ion-exchange membranes and valves are needed. Only 3-segment system can output electricity by non-electrochemical method. Huge current can be generated in liquid-loop comprising different concentration compartments; it is not the regular invisible lepton electronic current, but pure hadron or baryon ionic current, up to millions amperes that can be far larger than any superconductor's capability. Protons and small anions are preferred, so as to reduce mass transfer & ion hammer effect.

### THE SCIENCE BEHIND SUBJECT INVENTIONS AND PRIOR ARTS

Big idea needs big science!

1. Osmosis Pressure & Energy Density

The natural process known as osmosis was first discovered as early as back in 1748 by Jean-Antoine Nollet. Another one century later, in 1885, the first winner of the Nobel Prize in Chemistry, Jacobs Henricus Van't Hoff contributed the osmotic pressure equation that is similar with the colligative gas state equation: π=iMRT, where π is osmotic pressure, i—ion factor, M—concentration in molarity (moles per liter), R—gas constant, T—temperature.

As an example, for the regular sea water, at normal temperature, its osmotic pressure equals to 2*0.55*0.0821*300=27 atmospheric pressure. This significant pressure means that the river water can pump sea water 270 meter high by natural osmosis!

As to the energy density, just first exam the equivalence of pressure dimension:

Pascal=Newtons per square meter=N/M²=NM/m³=J/m³=Joules per cubic meter.

Therefore, the pressure itself does imply volumetric energy density. For easy understanding, as a preference, Joule is less used, but Kiwaho, i.e. kilowatt-hour prevails, aka 1000*3600=3.6 MJ.

For extreme osmotic pressure exploitation, saturated solution is always preferred. As the sea water concentration is only about 10% of its saturated state, therefore, the max energy density of sodium chloride salt solution should be calculated at 27*10=270 atm, i.e. 27 Mbar, according to Vant' Hoff equation, equivalent to 27 MJ/m³, 7.5 kiwaho per cubic meter.

In fact, we can easily find solute with very high molarity concentration for greedy energy density, e.g. hydrochloric acid, its saturated molarity is 16M, a significant increase compared with the table salt concentration limit 5.5M, thus 22 kwh/m³.

It is necessary to note that Van't Hoff equation is accurate only for very dilute solution, and late generations of scientists have found that the osmotic pressure of saturated solution can be measured to a significant larger readout at about double of calculated value from original equation. Many recent science papers fit out new equations for thick up to saturated solution.

Therefore, the estimated energy density based on classical equation is far less than real condition. But considering the gradual dilution from saturation while discharge during use, then no need of 200% re-adjustment, empirically 120% to 150% is reasonable.

In battery performance comparison, energy dimension kiwaho or kwh is too big, hence Wh/kg is used, and 1 Wh=3600 J. For example, the regular lead-acid car battery, its energy density is in the range of 33 to 42 Wh/kg.

As the specific weight of saturated hydrochloric acid is 1.3, therefore, if its osmosis physical battery or other style energy harvest apparatus is feasible, the ideal energy density is about 22000 wh/1300 kg=17 Wh/kg. With correction for saturation, 20 to 25 Wh/kg may be possible.

Above result shows that: the osmosis battery is inferior in energy density, only about 50% of the regular Pb-chemical battery, even further smaller percentage of lithium battery.

Disappointedly run away? Wait! Energy density is not all, cost can call last shot. Do you know the square-mile-scale super “battery” of USA 22 GW capacity of Pumped Storage Hydropower (PSH) in total 40 plants? Their average water head is less than 100 meters, that means its energy density is only 1 kJ/kg or 0.28 Wh/kg, even the lowest head 15 meter, i.e. 0.04 Wh/kg is utilized in PSH plant of O'Neil Calif. Everyone is happy with the cheap but tiny energy density of PSH. It is said that consumers can accept the energy storage cost <$300/kiwaho.

A well-designed osmosis energy storage battery may have on par cost with PSH. Not only the low cost, but also other shining features, such as superconductor performance, high magnetic field generation, and nuclear reaction potential ignition, all these will be amazingly magic.

Physical response is always superior to chemical reaction in other many performances, such as durability, low cost, eco-friendship, etc. Therefore, undoubtedly, the osmosis battery will win a great favor in the mature future.

In strict scientific sense, osmosis can be thought as weak half chemical reactions in physical appearance of salvation and/or hydration that is easy reversible.

2. Status Quo of Membrane Technologies

Osmosis application is greatly dependent on the maturity degree of membranes.

Nowadays, the price and quality of water semi-permeable membranes loom rosy. Especially, the water purification demand is advancing steadily membrane technology development.

In parallel, the hydrogen fuel cell demand is quickening the maturity of PEM (Proton Exchange Membranes). Currently the DuPoint's Nafion is getting cheaper and cheaper.

Desalination industry is also interested in electrodialysis technology, and this greatly promotes 2 kinds of membranes: cations exchange membranes and anions exchange membranes.

With market availability of all those difference kinds of membranes, the industry of osmosis battery or PRO (pressurized Retarded Osmosis) is almost at the starting line.

3. What Does the Pressure Retarded Osmosis (PRO) Technology Suffer From?

This method of generating power was invented by Professor Sidney Loeb in 1973 at the Ben-Gurion University of the Negev, Beersheba, Israel.

The world first osmotic plant with capacity of 4 kW was opened by Statkraft on 24 Nov. 2009 in Tofte of Norway. In January 2014, Statkraft terminated their osmosis project, because of many difficulties for scale-up, such as expensive membranes, silt and bacteria clog or contamination, cheaper competition from other renewable energy source, etc.

From the point of engineering, high pressure energy should be harvested by high efficient conventional hydraulic motor, and the best working fluid is the commercialized engineered hydraulic mineral oil with proper viscosity, anti-corrosion and temperature stability.

The carrier of osmotic pressure is usually aqueous solution, of course, it is never a decent choice to drive hydraulic motor, unless special complicated fluids interface adapting mechanism can be provided, but it will confront serious challenge in seal, mass transfer, and maintenance.

4. What Does the Hydrogen Fuel Battery Technology Suffer From?

In recent decades, lots of governmental and industrial funds are poured into research on hydrogen fuel battery, in bet of expectation of vehicle power excellent performance.

Unfortunately, awesome stymies are still ahead without hope to overcome in foreseeable short future, main Gordian knots are:

Detail intrinsic transient chemical reaction mechanism not yet totally understood, extreme costy metal platinum for catalyst, membranes not reliable, high pressure hydrogen gas storage.

Therefore, there is still a long long way to its commercialization and market acceptance.

5. What Does the Superconductor Material Technology Suffer From?

Zero electric resistance is really perfect, but unfortunately it currently is not convenient and even not affordable to sustain the required cryogenic extreme cold working space.

Even a workable liquid-nitrogen-immersed superconductor wire can only carry couples to dozens of thousand amperes current, otherwise overload will disable superconductivity. This still limits the bold applications with million amperes current huge demand.

Obviously, room temperature superconductor is the eventual objective, but the exploration path is definitely beset with rocks and brambles.

Although the theoretic first principles can guide the new material concoct, anyway, the trial-and-error is still the most used method, and it needs a long time to reach perfect.

6. Is There a Kind of Batteries Without Any Electrode?

Yes, I can build such one, but it is no longer the regular battery.

Conventional batteries always contain at least a pair of anode and cathode electrodes, and its outer extension poles are supposed to be usable positive and negative terminals. Electrodes with larger surface area are footed or submersed in solution or colloid subject to chemical corrosion-restore-corrosion cycle.

All electric loads can be driven by pumping or shaking so-called free electrons inside conductive wire-woven circuit. In a sense, it is the “free” electrons swimming in lattice space that do the user-wanted work. Battery Direct Current (DC) is good for pumping electrons from one end to another; and hydro-grid Alternative Current (AC) for shaking.

Electrons are leptons which masses are neglectable in comparison of hadrons or baryons, such as protons, neutrons and nuclei. In special sense, electric current is just electrons current and invisible; but in general sense, any charged hadrons or hadron-embedded particles flow can also be referred to as electric current, such as ions unidirectional flow in solution, though it is also named ionic current.

A serving loop of battery comprises dry side and wet side, and the dry side aka load-side conducts electrons current, but the wet side aka inside conducts ions current. Why are there two different kinds of flow in a loop, not electrons only? Because there is a technical proverb: ions cannot go ashore; electron cannot swim or dive in liquid.

Further, an interface is needed between electronic current and ionic current. Only chemical reaction can complete this interface by exchange of electrons and ions. The chemical reaction can result in deterioration or damage even explosion if inappropriate use or bad maintenance, such as the typical irreversible sulfation in car battery.

Therefore, the key to make electrodeless battery is to make an isolated loop that only allows ions flow inside, thus there are no lepton-hadron interface. As long as the ions can flow in designated correct directions which will be detailed in description of this invention, there will be a general sense electric current, though ionic current. The power to drive such a flow can be supplied by the phenomenal osmosis energy.

Of course, nobody can infuse hadrons into conductive wires of loads, then how can the loads get power from an isolated current loop without any terminal?

Electromagnetic coupling can fix above dilemma and make powerful enough special battery with zero volt output and electric neutral everywhere but great charged current!

At first, do not discriminate charged hadronic current, any charged current can induce magnetic field, no matter electrons current or ions current, and if same current amperes value, then same magnetic effect, no exception.

Because the energy-carrying ions current loop is direct current DC, none transformer can use it as input of primary coils and get output from isolated secondary coils, but luckily no problem to drive a motor by magnetic force.

Therefore, such an ionic current loop special battery can only have immediate mechanic power output in best convenience, or like a wound spring coil as used in antique clock.

If users insist in electricity output, then the simplest way is to couple the output shaft to an independent generator.

I have also another simple method to get electricity output, but only new physics can explain it.

Such a feature makes user's choice more flexible. For example, if a vehicle can be powered by it, then no necessary to ask for electricity, why not directly use its torque output which is just the eventual demand of all transportation utilities?

7. How Large Current Can the Osmotic Battery Sustain?

Firstly, let us exam which kind of charged particles have more freedom: “free” electrons in a wire or ions in a solution?

Strictly speaking, “free electrons in metal” is a fake claim, because ionizing a metal atom always requires more or less energy where natural environment is unable to generously offer. That is why one cannot surmise the electrons run fast in conducting wire: in fact, it may balk as slow as snail, for example, with 1 ampere current in a 2 mm diameter copper wire, one can exam electrons flow speed is only tiny 23 μm/s.

In contrast, “free ions in solution” is probably true claim. The classical Brownian motion reveals how fast a particle in solution can move. As an ion is far less weight than a visible particle in solution, thus its potential max velocity can easily surpass the observable Brownian motion.

Generally speaking, ions speed could match the sound velocity in its solution. For example, the sound speed in most aqueous solutions is about 1500 m/s. That is unimaginably tremendous in contrast of aforementioned electrons speed in conductor, therefore astronomical grade current is not difficult to form by ions flow.

Calculating is believing. Let us do some math on a near saturated hydrochloric acid with 12M concentration to get proton velocity for 1 ampere current.

1 A means 1 coulomb charge flow in 1 second, and 1 proton have 1.6*10⁻¹⁹ coulomb, i.e. such current is equivalent to a flux rate of 6.25*10¹⁸ protons per second time.

12M means 12 moles in 1 liter, by multiplying Avogadro constant, then it is equivalent to 12*6.02*10²³ H⁺ protons and Cl⁻ chloride ions per liter.

Therefore, the protons volume flux rate should be 6.25*10¹⁸/(12*6.02*10²³)=8.7*10⁻⁷ L/s=8.7*10⁻⁴ ml/s=0.87 μl/s.

If the carrying tube cross section area is 1 cm², then 1 A ionic current means proton linear velocity 8.7 μm/s.

Not like the expensive and heavy copper wire that is hardly to enlarge its diameter (gauge), for the liquid conduit, it is very cheap and convenient to use large diameter plastic tube, that means if enlarging to 1000 cm² section area, 1 A current only need 8.7 nm/s protons flow.

Anyway, no need of too greedy, still assuming 1 cm² tube, if the thunder lightning level current 1 million ampere i.e. 1 MA is needed, then the protons should run at 8.7 m/s. Obviously it is affordable and feasible, as it still far less than the supposed max Brownian speed 1500 m/s, thus further potential exists to secure more enormous current.

Now, let us check the mass flow, because it is hadron not lepton flow, no longer small deal.

Given proton mass 1.67*10⁻²⁷ kg, hence the mass transfer for 1 A current is:

6.25*10¹⁸*1.67*10⁻²⁷=10⁻⁸ kg/s; for 1 million amperes, proton mass flow=10 g/s.

Such a mass flow still no big deal, nobody can see a ripple of wave.

However, membranes area and rated flux, along with valve openness, can limit the mass flow. Manufacturers use GFD—Gallons per square Foot per Day, to rate their products. It is easy to convert to other intuitive unit: 1 GFD=1.66 L/m²/hr=0.47 μm/s, given water density 1 g/cm³.

Regular spiral wound osmosis membranes are rated about 8 to 20 GFD, or 4.2 μm/s to 9.4 μm/s. The speed range seems low, but it is for water, and same sign ions density is far smaller than water because of their mutual repelling, thus the selective ions exchange membranes can allow ions swimming to the designated direction at decent great speed.

Anyway, if the ambition to enlarge current is crippled, it is just an engineering issue, and the simplest method is to use large diameter pipe or add more membrane area.

It seems easy to get the 1 MA gigantic current by this method, in contrast, the great Sandia National Laboratories made a back-broken effort to acquire such current to power the Z-pinch machine, then wire shattered to extreme hot plasma with lots of neutrons release.

Now that creating immense electric current is so easy by pure ions flow, why it is so hard by metal wire in real world? Of course, the fake freedom of electrons in metal conductor should be blamed, that is why scientists are yearning for superconductors.

In my humble opinion, it may be a wrong way by exploring special formulated superconductor materials, because even the electrons Cooper pairs in superconductors, are still less freedom than ions in solutions.

A short-circuited heavy duty battery may produce thousands amperes, but risks a lot, even explosion, definitely not recommend to do so, because of too much ohmic heat.

As the current loop of a regular battery is a segmental hybrid current of electrons slow flow in external loads & intrinsic ions fast flow, therefore the total effect yields to severe throttling of electrons flow, just like traffic frustrated by a farmer's slow running tractor on highway.

Therefore, the only hope to reusably produce amazing current is by driving ions flow in specially configured electrolyte solution circuit! Osmotic pressure is strong enough to drive it.

Anyhow, there is no demand of million amperes level current in general applications, unless for crazy purpose, such as nuclear reaction catalysis or scientific research.

8. Mysterious Ball Bearing Electric Motor

As to how to convert the magnetic force into useful torque, lots of designs are available for choosing, however the simplest method is always preferred.

None design is more simpler than the ball bearings electric motor that has no windings, no magnetic field, no brush, but only 2 bearings supporting a conductive shaft with iron flywheel. In working state, large electric current flows from one bearing via shaft to another bearing, so as to drive it revolve, though it is necessary to provide hand-assisted rotation to any direction.

The science behind such an exotic motor is still controversial, though there have published tons of theses on it.

In my opinion, it may be the current-caused magnetization on shaft or flywheel that makes it revolve possible.

In real world, such a motor is absolutely useless, because it simply short-circuits power supply and draws remarkable current, even causing nasty heat and burning smell.

To replace the shaft of ball bearing motor with a section of pipe carrying ionic current in osmotic battery solution loop, and let iron flywheel slip on the pipe, the vast superconducting ionic current may also drive it, though efficiency is never decent.

This introduction is only provided as inspiration material for electric motor researchers or relevant enthusiasts to explore simple yet better design on hose coil motors

9. Ion-Current-Entrained Isolated Electronic Current

Not everyone loves to hook an independent electricity generator to the shaft of osmotic battery. Hence, I present an alternative method.

A proton is 1836 times heavier than an electron, yet proton & electron are attractive each other, thus flowing proton can easily entrain nearby “free” electron in solid, but if vice versa, it is harsh very much for electrons to drag protons though still possible.

In a sense, it is just like Coanda effect or effect applied in Dyson bladeless fans. Real funny, understanding electronics by fluid mechanics sometimes possible, isn't it?

Simply inserting a conductor plate alongside protons flow way, can be ready for electricity output, and the “alongside” positioning of plate is a must for not blocking flow. Of course, this method does not work if inserting the plate in negative ion flow channel.

Two terminals are connected to the upstream end and downstream end of the said plate, so as to prepare a closed path with internal ambush section for entraining electromotive force and provide voltage to outside loads. No worries of its self short-circuit, even disconnected loads.

Because nobody ever built a closed loop of charged hadronic current with pure cations flow as partial segment in history, therefore the ion-current-entraining electrons phenomena is just my sole discovery. Further experiments may be needed to exam its impact on current stability.

Protons means acid, and acid is corrosive, also electrons in the plate are not supposed to dive in solution for chemical reaction, thus the material for plate insertions should be picked from those expensive inert metals, such as platinum, gold. Therefore, this method may be not cheaper than a hooked generator, though its structure and installation are so simple.

Insertions in liquid need holes on tube wall with good seal for electric poles exposure, but if drilling then sealing job is not favored, then wrapping a copper foil around plastic tube may be workable too, though thick wall may reduce entrainment effect then result in low efficiency. Of course, directly using golden pipe is more simple, but sadly too expensive.

10. Ion Hammer Effect

It is well known that fast flowing water can result in serious water hammer effect if suddenly stopped inside pipe.

In osmotic battery, protons and anions will move in the engineered solution loop, but water molecules are not supposed to flow cross different membranes to other zones.

As ions are not electric neutral, thus there exists 2 kinds of hammer effects: one is caused by mass transfer, just as regular water hammer effect depending on how fast ions motion and how many total ions masses, another by classical electric inductance effect, that is governed by electromagnetism law: current is prohibited from sudden stop in an inductor.

Unlike a switch in regular electric circuit, herein solution loop is equipped with some valves for turn on or off the battery.

One switch is enough for a conventional electric circuit, but herein one valve may not be enough though it can cut off ions current in the loop, because ions flow need a complete loop to keep integrity and everywhere electric neutrality. Although ions loop is cut, however the osmosis-caused water flow crossing multiple membranes will be automatically activated if no multiple valves, because neutral water flow does not require complete loop.

Multi-valve configuration can make sure no leakage between different liquid segments, therefore almost forever shelf time without worries of battery capacity reduction, unlike a regular battery prefers to float-charging or preset interval recharging for long rest time, so as to avoid leakage or fatal failure.

Usually the mass hammer effect is not serious in osmotic battery, because even 1 million amperes only requires 10 grams protons flow per second in 1 cm² cross section pipe, according to prior calculation; but the inductance hammer effect is quite critical, just imagine how spectacular sparking show to cut off 1 MA current by a blade switch. Thus lowering speed of valve turn-off is very important for security.

The inductance of this electrolytic fluid system can be roughly estimated by classical electromagnetic formula for specific geometry setting, however it may not be assumed invariant, but also be dependent on valve openness.

The energy that is buffered in the magnetic field can be estimated by formula 0.5*L*I², here L is the system inductance, I is the current. For example, per 1 μH inductance, if the current 1 MA, then the stored energy is 500 KJ, obviously it is quite big.

By paralleling super capacitor(s), it can receive the buffered energy in magnetic field for safe shutoff, but how to do so is tricky because of electrodeless feature.

Before the first valve is closed, let loads indirectly drain most current, so as to abate inductance hammer effect. Also because of the existence of inductance, the ions current needs some time to rise gradually until equilibrium working state, the larger current, the longer time.

More experiments shall be attempted for deep understanding of this negative effect.

11. Sustainable Z-Pinch, C-Pinch, and Stratification

Super large current can induce great pinch effect. Many theories, equations and big science equipments have been developed to characterize and validate the destructive Z-pinch & theta-pinch in plasma state. But, sustainable pinches are less researched.

Although high magnetic field generation can be created by destructive methods, e.g. the dynamite Explosively Pumped Flux Compression Generator (EPFCG), however a durable high-field generator is more favored than one-offs.

If this osmotic battery is used in the same purpose, the pinch effect should be concerned, and obviously the ready theories for destructive pinches are not applicable.

Also here current is ionic current, and all ions can easily swim in solutions. The Lorentz force can only exert on ions that are carrying current and inducing magnetic field, other species in same solution will not be affected, e.g. the solvent or other non-current carrying ions with counter sign of charge if exists.

Firstly, let us study a straight pipe of solution between 2 protons exchange membranes. Here only protons can carry current, and anions and water can be regarded immobile if not considering the thermal motion. Thus protons will be Z-pinched toward central axis, water & anions will be squeezed toward wall. It means transversal stratification & potential implosion.

Secondly, let us study a straight pipe of solution between one cations exchange membrane and one anions exchange membrane. Here cations and anions run in counter direction each other but both carry electric current in same direction, hence they will be both pinched toward central line, and only solvent will be squeezed toward wall. This situation may combine cations and anions to reform neutral molecules that are then expelled off-axis, thus reduce current.

Last, let us study a solenoid of pipe coil with only protons carrying current. Interestingly, protons will be pinched toward circumferential wall. Now the magnetic pinch effect looks like centrifugal effect. What a coincidence with fluid mechanics! Transversal stratification occurs too but potential explosion. I name it C-pinch by symbolic mnemonics.

In fact, the non-destructive mild Z-pinch in conducting wire is almost same with ions current: “free” electrons are concentrated alongside axis, but metal atoms in lattice structure are immobile, and skin is positive charged because of transversal stratification.

No displacement or fluidity of structural atoms can make extreme hot Z-pinch condition in solid conductor & trend eventually to plasma disintegration, in contrast, liquid Z-pinch less likely.

For mediocre current, pinch effect can be neglected because of not noticeable. Even current large enough, but if cross section area also big enough, then current density can still be too small to exhibit pinch effect.

Pinch pressure is not uniformly distributed: for Z-pinch, the pressure reaches max in central axis, and linearly decrease in radial direction, and for C-pinch, the max pressure is in the wall contacting circumference.

Although wire Z-pinch can be used to demo nuclear fusion, it seems still not feasible to deal with such one-time puff. In contrast, Liquid Z-pinch exhibits great sustainability, thus if the working acid is engineered with isotopes deuteron & triton, and the ionic current conducting pipe is made slim so as to increase current density plus pinch force, and made of material with low neutrons absorption and high neutrons reflectivity, perhaps it is a great fusion reactor!

12. Why May High-Field Research Cost a Country an Arm and a Leg?

Challenging physic limits & exploring fusion nuclear energy are so seductive, that allured many countries have spent infinite money in special missioned institutes for achieving high electric field and high magnetic field.

In news media, those institutes milestone breakthroughs are often reported as hot science news, for example, it is said that: USA Sandia National Laboratories Z-pinch machine can generate record high multimillion volt & high current multimillion ampere; the National High Magnetic Field Laboratory can generate record high 100 Tesla; Germany Dresden High Magnetic Field Laboratory can also approach the 100 Tesla.

Behind the great record achievements, there always is unbelievable vast investment that even a small country is not affordable by her GDP.

Why is it so expensive? One side is that such a challenge just fights with the Great Nature, for example, a pulsar star magnetic field can reach 10¹⁰ Tesla level, how can humankind replicate it on the Earth? Another side may be that a detour of technology is unconsciously chosen. Perhaps there are other unknown reasons.

Here, I only comment on the prior approach for high magnetic field. My opinion: relying on special solid materials is probably not smart, as the reason is mentioned many times afore—“free electrons” in any conductor is not really free.

As per calculation, for 100 Tesla generating, the pressure of running electrons against wire body, aka C-pinch pressure, could be as high as 30000 atmospheres, so that a laboratory may have to be evacuated before triggering the experimental apparatus.

The freedom of ions in a solution is far greater than electrons in the ideallest metal conductor, and solvent molecules are mobile but metal atoms are cemented in conducting lattice, therefore colossal ions current for sensational magnetic field is more economical and feasible, even up to 1000 Tesla possible, and the potential highest pressure is just the osmotic pressure up to only 2000 atmospheres that can be easily contained with prior industrial level.

One day, if 250,000+Tesla can be generated, then human beings will have instant nuclear fuel: natural isotope rhenium-187. According to my calculation, under such high magnetic field, all atomic electrons, including nuclei, will be converted to atomic size eddies in situ, not large size helical orbits twisting around weak magnetic field lines, then the naked nuclei Re-187 half life of beta decay will be shortened from 42 billion years to 33 years.

Although ripping off atoms' all electrons can be done by bombardment of high energy particles, however it is not a good bargain because electric field is always dissipative field.

Magnetic field is conservative field where a charged particle can losslessly hold private energy in its own vortex curled by Lorentz force, and curling size proportional to momentum.

High magnetic field is also crucial to nuclear fusion energy production. The most researched magnetic confinement method is the donut shape Tokamak reactor. If this osmotic high field generator works well, then it can greatly accelerate the progress of fusion technology research!

13. Last Word in This Section

In this patent application, it is enough to simply help peers quickly understand my inventions with only compact scientific materials, thus discussing too deep about science will stray from the purport. This interdisciplinary research is complicated very much, and above theory disclosure is just a small portion of my full thought products. For the readers with great interest in this theme, welcome to backorder my scholarly works or employ me for your projects.

### SUMMARY ON SUBJECT INVENTIONS

In a sense, it is physical battery, not chemical battery!

A traditional battery pumps out electrons from negative terminal to positive terminal via an electric load, thus voltage must exist across the 2 terminals, so as to exert pressure on electrons. As explained in previous science texts, in order to power the electrons “pump”, chemical reactions should take place around the 2 terminals feet area: internal electrodes.

In attempt to get rid of chemical reactions, I have to eliminate the electrons “pump”, and only generate hermitic ionic current loop, so as to provide invisible strong magnetic field in immediate vicinity for loads.

A load can be contactlessly powered by this kind of magnetic battery, as long as it closely couples with the magnetic field, and properly converts magnetic force into torque power.

How to make an ionic current loop is just the key of subject inventions.

Nothing can be automatically in motion. I utilize osmotic pressure to power the current loop.

There is phenomenal osmotic pressure across 2 sides of a membrane that separates high concentration of solution and low one, and concentration equalization is the 2 solutions common wish, thus solute in high concentration solution craves migrating to low side, as well as the solvent in low concentration craves migrating to high side.

A membrane can be designed to only allow one specie pass through and block others. Subject inventions need 2 kinds of membranes, one is Cations Exchange Membrane (CEM), and another is Anions Exchange Membrane (AEM).

Because proton is the lightest cation, thus Protons Exchange membrane (PEM) is a sub-category of CEM, and wherever CEM is mentioned, it can be PEM as favorable choice in any embodiment.

As there is no magnetic field in neutral current, thus electrolyte solution must be used, so as to enable ions current and facilitate magnetic field generation. One specie electrolyte is enough.

In a closed loop consisted of a “string” of different concentration solution segments separated by membranes, it is never possible to let ions of only one specie, for example, only protons, run full circle, no matter how powerful the osmotic pressure or how to configure the loop.

Therefore, I have to employ both positive ions and negative ions to complete a current loop. Although they run in counter directions, all driven by osmotic pressure, however the 2 species of ions cooperate to realize same direction of logic electric current.

In the science texts, a mass transfer flux 10 g/s in protons is deduced for 1 million amperes, but no mention of anions. As selectable minimal mass of anions unluckily heavier than proton of cations typical choice, AEMs have to endure higher mass transfer flux, for example, chloride anions, 360 g/s per million ampere current. Thus if hydrochloric acid is used, for 1MA current loop, different mass transfer 10 g/s H⁺ & 360 g/s Cl⁻ must be simultaneously occurs crossing respective cations & anions membranes in mutual counter direction.

Like as the classical electric current in a conducting wire, such special selective charged-mass transfer current, or engineered charge current, can also induce magnetic effect.

As how to turn on or off the engineered charge current loop, it is another point of inventions.

Obviously, a regular electric switch will be useless here, thus I creatively use plumbing valve(s) to control the on/off of logic electric current loop.

Quite a proportion of ordinary battery users are nostalgic, they will instinctively look for the positive and negative terminals and polarity signs before using a battery.

I am reluctant to spoil users basic need, thus alternative method is invented to cope with the direct electricity output by a submersed electrode with positive and negative terminals.

Although the 2 electric terminals are connected on the same electrode, however, no worry of short-circuit, it is not dummy trick, because as per the previous science texts, there is a special effect of cations-flow-entrained electrons flow inside the electrode, and this effect can pump electrons from one terminal at the upstream of cations flow, to another terminal at downstream, then the circulating electrons can power external electric load.

Unlike the regular electrochemical cell, here the output voltage is hard to predict, and it depends on the terminals span alongside cations flow and osmotic pressure.

Usually, the electrode is assembly of multiple parallel thin plates or concentric thin wall cylinders, and it must be deployed inside the segment with only cations flow and without anions flow, also the orientation should not block flow way.

Because high protons concentration means strong acid, so the said electrode should use anti erosion material, and though gold or platinum highest performance, high cost may be an issue, thus other cheap choices are welcomed, such as graphite, Hastelloy B2 Ni-Mo alloy, etc. Electroplating platinum or gold on cheap metals is another trade-off choice, but suffers from the timed schedule of re-electroplate or replacement, depending on thickness of E.P. layer.

As a trade-off, replacing acid electrolyte with salt, can decrease the corrosion, then regular cheap metal, such as copper can be used as electrode, but higher mass transfer in cations osmosis, may limit current maximization, e.g. sodium cations, membranes will see 230 g/s/MA.

The electrode extension for exposure of battery terminals should avoid welding not same materials, because two different alloys electrically connected in a humid, even mild acidic environment may act as a voltaic pile and corrode faster.

Because there always exists very thin passivation film on surface of any anti corrosion alloy, and less even no free electrons reside inside the film, and though the underneath deep electrons can still be entrained by nearby cations flow, however, the said film reduces the effect.

If gold or platinum is not used as electrode, then gas breather(s) should be considered for safety, because anti corrosion does not mean zero but very slow corrosion, and dangerous hydrogen gas can accumulate gradually.

To make a workable ionic current loop with potential ability of direct electricity output, at least there must be 3 segments of membrane-separated solution compartments with different concentration to form a closed trough or channel, of which, one segment is supposed of pure water before first discharge or after full recharge the battery, and the other 2 segments: one is supposed of the highest even saturated concentration of electrolytic solution; another dilute, e.g. 50% of the highest one.

For convenience and coherent nomenclature, the container or compartment that holds the highest designated concentration solution can be referred to as High Segment or Source Segment as its weight decreases gradually during discharge, the container or compartment that holds the lowest even zero designated concentration solution can be referred to as Low Segment or Destination Segment as its weight increases gradually during discharge.

The container or compartment with mediocre designated concentration can be referred to as Middle Segment, and its concentration is about half of the High Segment, and always keeps constant while system discharge or recharge, more distinctly, it only allow cations especially protons flow in & out, so as to enable entrainment effect on electrons of submersed electrode assembly for direct electricity output.

Of course, one segment solution cannot provide current loop, because of no osmotic pressure. Although 2 segments can work, however it only outputs magnetic field or torque, is unable to output direct electricity, and an extra torque powered generator should be added for such purpose, because there are simultaneously both cations flow and anions flow in counter directions in all 2 segments, thus there is no entraining effect on electrons hosted in electrode.

In 2-segment system, one segment must be High Segment, another Low Segment; its one end is separated by anions exchange membrane, another end by cations exchange membrane.

In the 3-segment system, there are 2 sheets or cartridges of CEM. The segment between the 2 CEMs or PEMs, i.e. the Middle Segment, features special properties: (i) anions inside can be regarded as stationary; (ii) total mass is conservative, i.e. flow-in mass=flow-out mass; (iii) ions concentration is always invariant or constant, during either recharging or discharging; (iv) it is the only place where an electrode assembly can be submersed for direct electricity output by entraining effect; (v) it is the midway of cations osmosis path from the Source Segment to Destination Segment, thus sometimes it is also referred to as Midway Segment.

The required pieces of membranes equals amount of segments for proper separation, and both cations and anions exchange membranes are needed. As usual anions are heavier and size larger than most used cations i.e. protons, thus only one piece of anions exchange membrane is enough in whatever segments configuration, so as to minimize mass transfer and cost.

As to how effectively output torque by electric-magnetic interaction, it is not the target of subject inventions, a detached invention is preferred, though I can present simple sketch or heuristic materials, anyway, there are many mature motor technologies and ubiquitous applications. However herein, there is a different situation that plastic hose/tube and its windings will replace conventional enameled copper wire windings either in stator or armature.

In fact, in all electric motors, it is the fighting action between 2 magnetic fields that drives shaft rotation, though only permanent magnet or excited magnetic field and electric current are the obvious facts, however another magnetic field is hidden behind the obvious current.

Therefore, to output torque by utilizing this ready available ionic current, another magnetic field should exist. Of course, using permanent magnet is the simplest method.

One may wonder why not to create an excited magnetic field in situ, by branching an auxiliary hose from main hose that carries ionic current. For current in copper wires, it is not a problem, but here liquid hose may confront big challenge in sealing while rotor revolves.

As swivel hose can be seen in some household applications, its bushing and seal technology could be improved for application in heavy duty hose coil ionic current motor in future.

The 2-segment osmotic battery system will be temporarily dismal until the said motor technology is mature, because of its impossibility of direct electricity output; only 3-segment system can see a quick boom because of its immediate electricity availability.

Although multiple valves are recommended to deploy in the loop, however only one valve should be regarded as main valve for purpose of controlling turn on or off whole system, all other auxiliary valves are usually always turn on unless idle or shelf time is longer than a threshold value. Degagely turnoff all auxiliary valves is a good practice to prevent water transfer from osmosis effect between different segments, because only ions osmosis needs a complete loop, but water osmosis can occur in any interface with bilateral concentration differentia.

Because the total content mass of High Segment & Low Segment is changing during discharge and recharge, therefore only inside these 2 segments, there should be air-liquid level interface in gravitation field. As to the Middle Segment, it is recommended to disallow air-liquid interface. All tubes or pipes, especially those in coils, must purge air-liquid interface anywhere, and be mildly pressurized by natural gravity for reliable ionic current, no matter where are those inlined, even inlined to High Segment or Low Segment.

As to recharge criteria, no special advice, no memory effect, it always is acceptable recharge moment, early or late, as long as users feel output weak, or threshold value is reported by sensors that monitor concentration difference in the highest and the lowest segments. It is Okay either by reverse osmosis or replacement of solutions in both segments with the highest and lowest concentration. For the 3-segment system, there is no need to do anything for the segment between 2 CEMs during recharge.

Recharge by RO (Reverse Osmosis) is a mature popular technology that is out of main scope of subject inventions. Some plumbing fittings on all compartments or segments should be reserved for hooking up offline RO device.

For automobile application, it is recommended to quickly replace exhausted solutions with fresh solutions by any commercial service provider, just like as fuel up vehicle in gas station.

If the electrolytic solution is the free seawater or other dirty cheap stuff, then drain & dump of exhausted solutions may be better or more economic than reverse osmosis process of recharge.

As to battery endurance time, it is determined by magnitude of discharge current, membranes area, volume of High Segment and Low Segment, but nothing to do with Middle Segment for 3-segment system. Just like narrowing river course can speed water, narrowing the inlined tube/coil can accelerate ions too, hence increase current density & magnetism.

### DETAILED DESCRIPTION WITH EMBODIMENTS

With enough previous texts description on the subject inventions, it is time to graphizate or visualize typical or preferred embodiments. A drawing is worth of thousands words, isn't it?

1. The Simplest Osmotic Battery

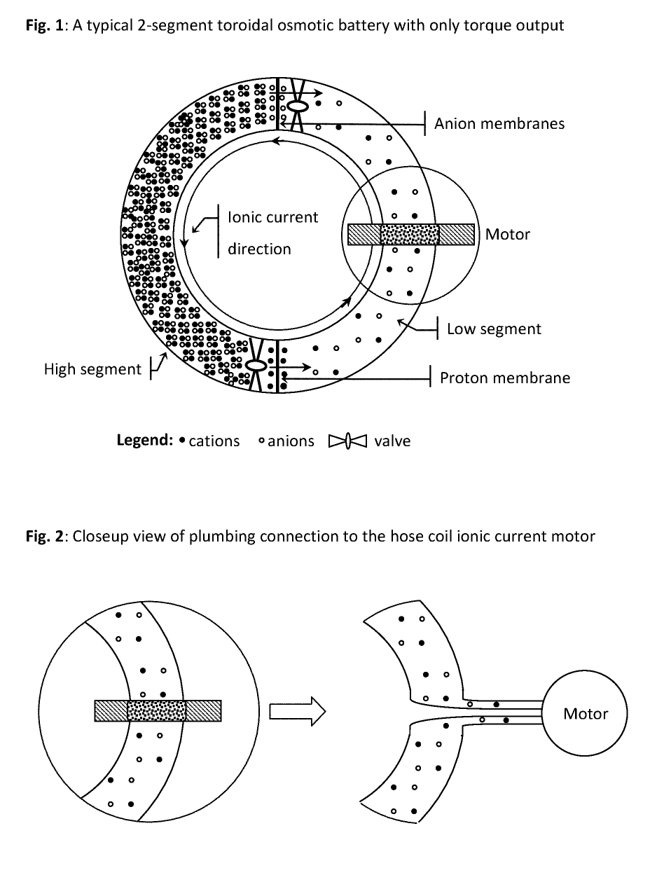

FIG. 1 illustrates a 2-segment scheme with torque output only. To streamline ions flow, whole system is designed in toroidal shape though not mandatory. Every single segment is in semicircle appearance, one is just the afore-defined High Segment & supposed to hold high concentrated electrolytic solution, e.g. hydrochloric acid HCl, and another Low Segment to hold pure water. Both ends of 2 segments are docked together with proper membranes separation, one is protons exchange membrane, and another anions; 2 valves are also deployed near ends.

Although the membranes seem like circular disks or oblong screens, in fact, in most large embodiments, this drawing sketch can not reflect the real implementation, instead, available membranes are fabricated in spiral-wound cartridges, and the interfaces between the 2 segments are implemented by plumbing means with pipes which diameters are lesser than the end area of segments, fittings, membrane cartridges plus racks. The valves are installed inline pipes, and respective positions are not important.

Only in micro embodiment, the membranes may be just simple disks or rectangular screens, and the valves are simply integrated with the segments. However, such an application of micro osmosis battery is rare, as other type of batteries can be better for this application.

From this figure, it is easy to identify which one is the high segment and which one is the low segment. The density of ions, aka concentration of solution is symbolically visualized by graphic elements, the densely drawn one is the High Segment, and the diluter one is the Low Segment.

As to the arc appearance of solution containing segments, either the High Segment or Low Segment or Middle Segment if exists, it is also not mandatory, even straight line edge is allowed. Drawing curvature in this figure is only for convenience and beautification, in fact, the closed current loop does more matter, just as nobody cares about whether a wire kinks or not in a electric circuit. This rule applies to all hereinafter figures.

While driving mechanic loads, all valves must open first, then osmosis will automatically begin—H⁺ swarm in high segment sprint to low segment via protons membrane as well as C1⁻ via anions membrane in counter direction, and then ions current loop forms, magnetic field is induced.

To output torque power, a proper ionic current driven motor is needed. Because it will digress from subject if detailing such a motor, thus the motor is only drawn as a “blackbox” which is illustrated inside the dot-line-circle, and this practice hereinafter applies to all drawings.

FIG. 2 is the closeup view of plumbing connection to the said motor blackbox. Usually the inlet and outlet hoses will have small diameter, the fittings on segmental containers may have larger diameter and thread, thus some adaptors may be necessary, all just trivial plumbing job.

Because this special ionic current motor contains soft hose windings coil, so the hosting segment must have 2 sub-segments for inserting soft hose in the middle.

This drawing sketch may not reflect the real implementation. The ends of 2 sub-segments can be flat surfaces where the barb style hose fittings could be welded on as a favorable choice.

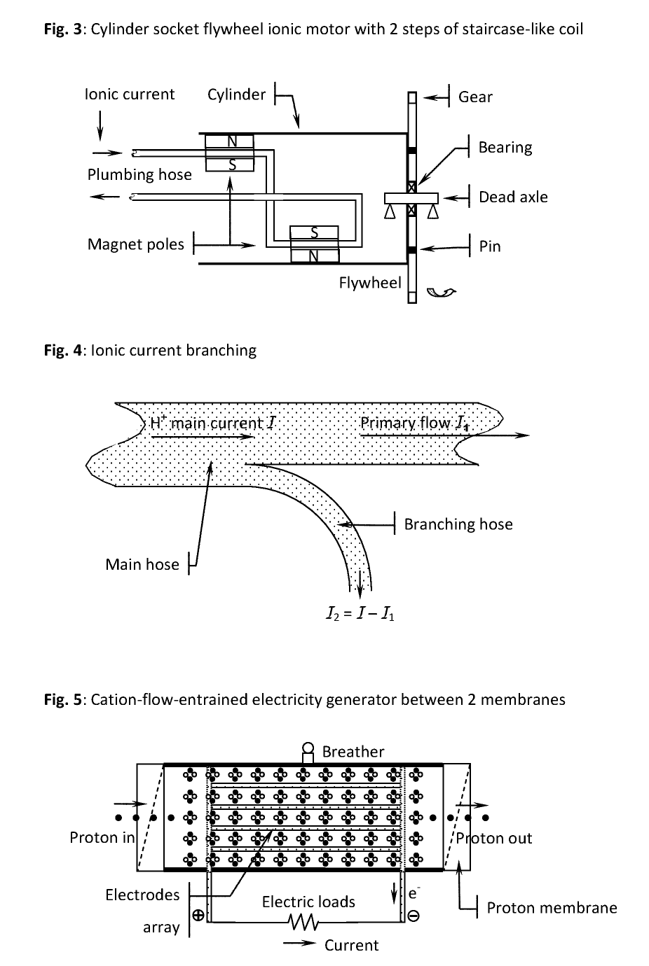

As a courtesy, a simple motor design sketch is presented in FIG. 3, where a cylinder socket pinned with flywheel plus gear is supported by a bearing based on a dead axle of chassis. There are 2 permanent magnets fasten on inner wall of the said socket with proper polar orientation. When the magnets pass through the nearby of hose that carries ionic current, its rotation will be powered with some torque, then inertia will make this event reoccur.

Although only 2 magnets are drawn in the figure, anyway, in order to torque the socket or flywheel more times per 360° full turn, more magnets can be deployed like helix staircase around the inner wall of socket, then inertia only need rotate socket a few degree of angle for next torque harvest, & correspondingly the immotive hose coil will become more complicated.

This FIG. 3 ionic motor is only for general reference and not guaranteed of workable or feasible, also, nothing is claimed from this figure in this patent application.

Therefore, the so-called toroidal shape is not a hard demand, it may just be a typical shape, the real shape can be anything, as long as a closed ionic current loop can form by whatever plumbing means, so as to route ionic current leaklessly to a special motor for torque output.

Although branching a fractional ionic current from main pipe is notdifficult, even as simple as illustrated in FIG. 4 wherein branched hose, I₂=I (main current)−I₁ (primary current), however using this fractional current for other auxiliary purposes may be not bad idea, but exciting second magnetic field in a motor may face challenge of how to periodically reverse liquid flow in simulation of commutator and brushes in excitation circuit of regular DC electric motor. And any liquid carrying coil may be not fit of ensemble motion, such as used in rotor or armature.

This FIG. 4 is just a common sense illustration, and nothing is claimed from this figure in this patent application.

2. A Non-Electrochemical Method to Output Electricity by Entrainment Effect

As described in the science texts, pure cations flow can entrain distinct electrons flow inside properly submersed & orientated metal sheets. FIG. 5 shows an embodiment with assembly of electrode comprising array of parallel plates or concentric cylinders.

To secure pure protons or cations flow, the utilized segment should be in-between 2 membranes with cations exchange capacity.

The soaked assembly should not block the ions flow, thus concurrent orientation is required, and the endpoint at upstream can be used as positive terminal of electricity output, as well as the downstream as negative terminal.

The material for such electrode should be anti corrosive, and a breather is needed for safe release of gas, in case of gradual pressure accumulation caused by electrode slow corrosion.

Adopting this method, an osmotic battery not only can output immediate torque, but also convenient electricity as the essential & pristine function.

3. A 3-Segment Osmotic Battery with DC & Torque Double Outputs

Although 2-segment system is so simple, however it only provides torque output and needs await maturity of ionic motor technology. Even ionic motor available, anyway, for electricity output, a generator has still to be hooked on the motor's shaft.

The 3-segment system can overcome the said demerit by cheaply utilizing entrainment effect for electricity, despite there is no standard voltage.

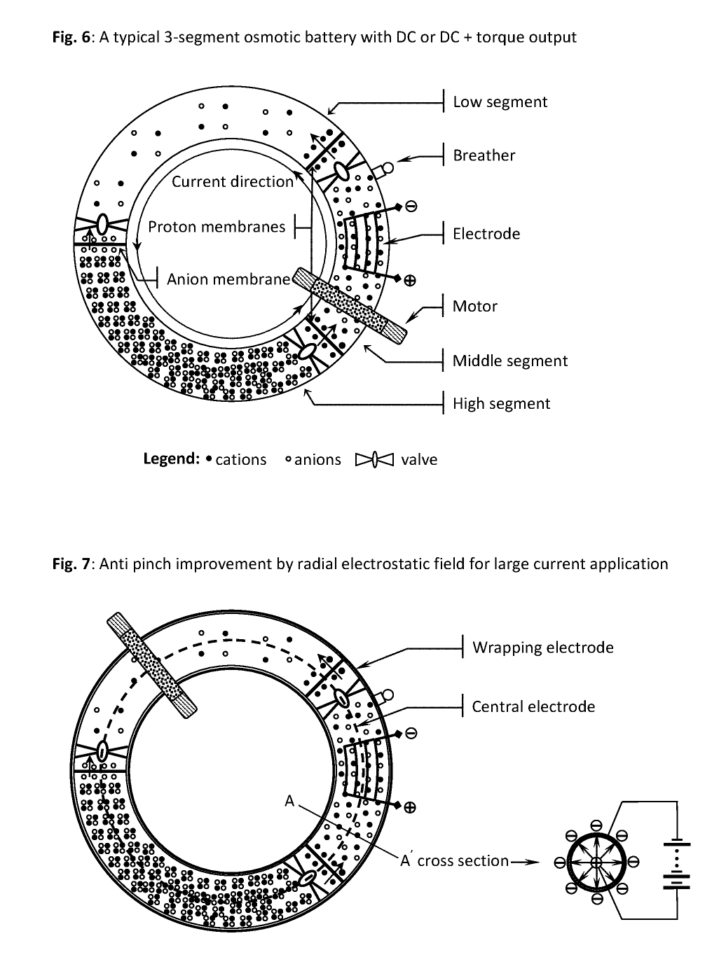

FIG. 6 is a typical embodiment. It comprises 3 segments of liquid compartments or pipes, and the High Segment and Low Segment as in basic 2-segment system are both reserved, the only added segment can be called Middle Segment (also predefined in the summary section) and used to hold mean value aka average concentration, for example, if the concentration in high segment is 50% by weight, then 25% in this middle segment, and reaffirmingly, here concentration will never change both during discharge and recharge, i.e. whatever amount & content flowed in from one end is just exactly the same that will flow out at another end, thus sometimes it is referred to as Buffering Segment.

Electrons entrainment effect requires vicinal flow with involvement of only cations not anions, and the Middle Segment in subject system can just satisfy the demand. Despite of increasement of complexity & cost with extra segment plus membrane, however it makes possible to directly provide convenient electricity output.

Total 3 segments plus 3 membranes are needed, of which, 2 are cations ions exchange membranes and 1 is anions ions exchange membranes, also extra 1 valve should be added.

As to the motor in 3-segment system, it can be located at any segment. Anyway, hosting in the Middle Segment is highly recommended, because if both cations and anions simultaneously flow in counter directions inside slim hose coil, friction increases, motor efficiency will decrease.

In fact, with the availability of electricity output, the torque output may be a redundant, as users can alternatively convert electricity to torque by mature motor technology, unless hose coil ionic current motor can be made more powerful and economical in future.

No need too big volume of Middle Segment, as its root purpose is only for entrainment electromotive power output, therefore fully covering the electrode assembly is the minimal requirement unless it also hosts ionic motor for torque output.

Although the osmotic pressure across the High Segment and Low Segment is about double larger than that across High Segment and Middle Segment or across Middle Segment and Low Segment, however the ratio of cations flow rate to anions counter flow rate will not be determined by the said osmotic pressure difference, but always keep constant, because charge balance for integral current loop can impose far greater force than osmotic pressure, it simply prohibits anywhere positive or negative charges macro deficit or surplus.

The DC output terminals can also be used as input terminals, in this occasion, the electrons flow will be forced to change direction, so as to reverse osmosis (RO). Unluckily an independent regular electric supply may not power this special RO means, because the electrode assembly is short circuit, but the DC output of another osmotic battery can input current to this osmotic battery without worry of short-circuit so as to realize peer-to-peer recharge by online DC entrainment driven RO, despite it may be less efficient than offline pressurized reverse osmosis.

The previous comment on the toroidal shape in the description of 2-segment system can also apply to this 3-segment system. That is: the shape can be anything, as long as a closed ionic current loop can form.

Again, this number 6 figure drawing sketch may not reflect the real implementation, instead, available membranes are usually fabricated in spiral-wound cartridges, and the interfaces between the 2 segments are implemented by plumbing means with pipes which diameters are lesser than the end area of segments, fittings, membrane cartridges plus racks. The valves are installed inline pipes, and respective positions are not important. To eliminate unnecessary repeats, this rule applies to all hereinafter figures.

4. Improvement to Correct Pinch Effect

Either in 2-segment system or 3-segment system, there exist segments that allow mutual opposite bidirectional flows of respective cations and anions.

If the current density big enough in whole system or somewhere of the current loop, the pinch effect may happen.

As to single specie of ions flow, the said effect may not pose negatively, except transversal stratification with flowing same sign charge carriers high concentration nearby central line. Obviously the Middle Segment of 3-segment system will be affected in less severity.

But to dual species of ions flow, both positive and negative ions will be pinched alongside axis, and mutual counter motions may enable cations and anions head to dead collision, then re-neutralization or deionization may unexpectedly occur, and then current will be diminished or change to low current equilibrium. Thus, pinch effect should be avoided in these segments.

In FIG. 7, a method is applied to alleviate ionic current pinch effect by exerting a radial electric field that draws cations toward wall of pipe and anions toward axis.

A high voltage generator is needed to set up high enough electric field, though undrawn here, this can be powered by auxiliary small capacity rechargeable battery at start, then the osmotic battery takes over to maintain it after stable state ready. In the right-bottom of the figure, the cross section A-A′ of the Middle Segment shows how the anti-pinch DC high voltage is applied.

Because electrostatic field only consumes tiny energy to charge the parasitic capacitor, thus it will not significantly encumber system efficiency.

The negative polar of anti pinch electric field can be formed by wrapping a metal foil around pipe, and positive polar can be fixed by deploying a central metal wrie ring with plastic skin for electrical insulation. In fact, the same view will be seen in other segments.

As single specie of ions current is mildly impacted with the current offset by pinch effect, therefore the Middle Segment may not be considered. If only take action in High Segment & Low Segment, the polarity of electric field can be flexibly set, in other words, the wall negative & axis positive polarity configuration is not the only choice, even total reverse, i.e. wall positive & axis negative is also workable though undrawn in the figure.

If some segments are equipped with big tanks for large scale energy storage, then its ionic current density will be locally very low even the current is really huge, thus also no need of special consideration for therein pinch effect, just focus all efforts on those narrow segments, such as the sub-segment of tube coil in solenoid style.

Anti pinch may not be always wanted, for example, if intend to have nuclear fusion reaction in the Middle Segment, then the greater the pinch effect, the better the fusion performance, even a pinch-promoting high electrostatic field is desired, with negative polarity at central axis and positive polarity on pipe shell, i.e. a total reverse of the anti pinch setting.

In this figure, the ionic motor is drawn in the Low Segment, though actually it can be sitted at anywhere of any solution segment if preferred and apce allowed.

Also a breather can be seen in the Middle Segment, as the entraining electricity generator assembly is hosted in that segment and the imperfection of the assembly inertness may need it.

5. High Magnetic Field Generator with Auxiliary Electricity & Torque Output

High magnetic field apparatus is highly sought-after for special interest groups that usually challenge the manmade limit of magnetic field so as to explore exotic material properties or potential clean nuclear energy, such as fusion reactor. The nowadays record is about 100 Tesla for sustainable generator with limited reusable times.

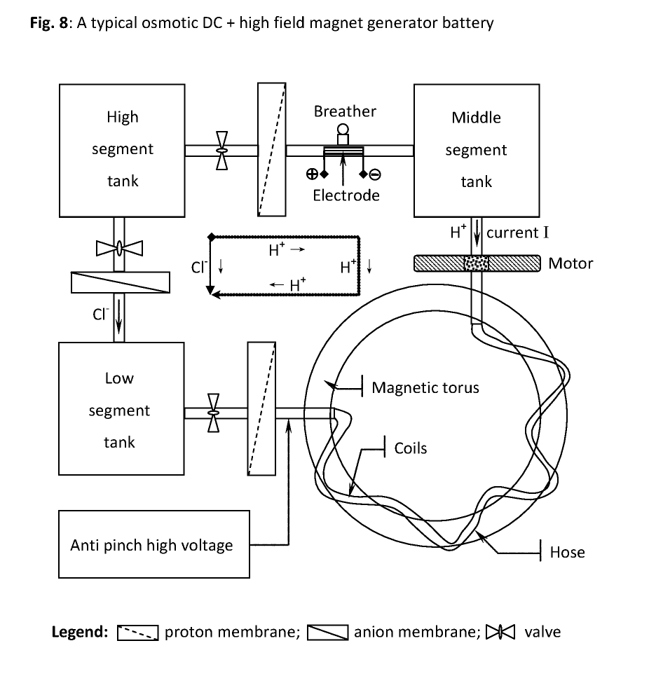

To cope with this demand, FIG. 8 suggests an ionic current based high field generator. It comprises a High Segment embodied as a high concentration acid solution holder, an equivalent capacity Low Segment embodied as a tank that holds pure water at start, and a Middle Segment embodied as a thin concentration solution and an extension of plastic coiled pipe so as to generate the wanted high magnetic field inside a toroidal space.

The volume of middle segment tank can be as small as possible or precticable, because it only functions as a buffer means.

This system can simultaneously output electricity by application of electrons entrainment effect, as well as output torque power by aforementioned special ionic motor, though both outputs of electricity & torque may be auxiliary, as the main objective is for high magnetic field generation.

Permeable magnetic material core is not necessary for extreme high field unless for midrange field, because no matter whatever high relative permeability μᵣ, it is only workable under a limited strength of magnetic field, as long as field strength is over a tipping point, μᵣ will gradually decrease to as same as vacuum or air 1.0 without exception.

Pinch effect caused by huge ionic current can be negative to the high field generator, thus there is need of special engineered tube coil with corrigible electric field implement.

The high voltage generator module in the figure is for the purpose of anti pinch effect, and it can be powered by the electricity output, despite a starting rechargeable battery may exist.

Depending on occasions, a straight coil of solenoid hose may be better than toroidal design in specific application, though undrawn in the figure, and the magnetic field in this case is similar to a bar permanent magnet.

The membranes in this scheme is recommended to be the popular type of spiral-wound cartridge which outlook is commonly seen in mainstream system of reverse osmosis pure water production, because extreme high ionic current is needed and this kind of membranes configuration can scale up easily by parallel addition of more membranes cartridges .

Area of membranes makes big sense to the system capacity, the larger the area, the huger the potential ions current, the quicker the discharge, and the shorter the recharge interval time.

Turnoff the system may encounter ions hammer effect, and it can be overcome by slowly closing valves as main measure.

In this figure, even the detail ionic current loop is illustrated under the assumption of using hydrochloric acid as working osmosis media: the dotted-loop comprises positive ions protons stream and negative chloric ions stream, and it forms a clockwise logical electric current loop.

Also, the entraining electrode assembly is drawn between the High Segment tank and the Middle Segment tank; the ionic motor is drawn at the downstream of the protons outflow port of the Middle Segment tank, and before protons enter the solenoid coil.

### REFERENCE

1. Method and apparatus for generating power utilizing pressure-retarded-osmosis, U.S. Pat. No. 3,906,250
2. Semi-permeable membrane for use in osmosis and method and plant for providing elevated pressure by osmosis to create power, U.S. Pat. No. 7,566,402 B2
3. Hybrid RO/PRO system, U.S. Pat. No. 7,871,522 B2
4. Osmotic energy, U.S. Pat. No. 8,099,958 B2
5. Utility scale osmotic grid storage, U.S. Pat. No. 8,795,525 B2
6. Osmotic Heat Engine, US20100024423 A1
7. Method and apparatus for osmotic power generation, U.S. Pat. No. 9,023,210 B2.

All inventions herein contain key implementing methods and preferred embodiments, and may be flexibly embodied in other specific forms or consisted of different geometry or other configurations without departing from its spirit or essential characteristics.

There are 2 kinds of membranes both used in subject inventions, one is AEM (Anions Exchange Membrane), and another is 1 CEM (Cations Exchange Membrane). Because proton is the lightest cation, thus PEM (Protons Exchange membrane) is a sub-category of CEM, and even CEM is mentioned in claims, it can be PEM as favorable choice in any embodiment.

For convenience, the container that holds the highest designated concentration solution can be referred to as High Segment or Source Segment as its weight decreases gradually during discharge, the container that holds the lowest even zero designated concentration solution can be referred to as Low Segment or Destination Segment as its weight increases during discharge.

If there are 3 containers, the container with mediocre designated concentration can be referred to as Middle Segment, and its concentration is larger than the Low Segment and less than the High Segment, usually about half of the High Segment, and always keeps constant while system discharge or recharge, more distinctly, it allows either only anions or only cations flow in & out.

Although no claim seems to proclaim the system with 4 or even more segments in series loop connection, however obvious dummy extra segment(s) cannot dodge the essential claims.

1. A battery system that enables osmotic pressure to generate complete loop of ionic current, the loop is routed by 2 or 3 segments of electrolytic solution separated by membranes, and both AEM & CEM must be used. The unique source of head diffusing ions is the High Segment, and the unique final destination is the Low Segment. For osmosis path in 3 segments, the diffusing anions or cations will trip via Midway Segment or Middle Segment.

2. In addition to claim 1, the ionic current complete loop comprises partial path of cations flow and partial complimentary path of anions flow at opposite direction; there must be same number of pieces of different purposed membranes that separate different segments, and the deployment of membranes must facilitate the head anions and head cations osmosis from source to destination at opposite directions to form complete loop; at least 1 valve must be inlined for turn on or off the loop;

3. In addition to claim 1, for 3-segment system, the 2 ends of Middle Segment must be separated by 2 membranes with same sign ions selective osmosis; usually 2 protons exchange membranes are preferred, though 2 AEMs can be used for special purpose.

4. A method that generates the forced flow of electrons in submersed electrode by scavenging entrainment energy from vicinal cations flow; the electrode assembly usually comprises a bundle of equidistant concentric thin cylinders or parallel plates; the orientation of assembly must be anticorrosive and enable ions to flow comfortably through all gaps; the assembly one endpoint at upstream serves as footing point of positive voltage terminal, and another endpoint at downstream as negative terminal.

5. A system that generates super high magnetic filed by multiplying the ionic current loop carried by conduit coil solenoid wherein osmotic pressure powers the ionic current; and that is based on the afore-claimed osmosis battery framework with amenity of auxiliary electricity and/or mechanic work output terminals.
